(19) United States
(12) Patent Application Publication
(10) Pub. No.: US 2026/0327435 A1
(43) Pub. Date: Oct. 22, 2026

(54) AN ANTIFOULING COMPOSITION

(71) Applicant: Svenska Aerogel AB, GÄVLE (SE)

(72) Inventors: Peter Norberg, GÄVLE (SE); Diana Morari, GÄVLE (SE); Nader Nikkam, SUNDSVALL (SE)

(73) Assignee: Svenska Aerogel AB, GÄVLE (SE)

(21) Appl. No.: 18/880,790

(22) PCT Filed: Jun. 30, 2023
(86) PCT No.: PCT/SE2023/050687

§ 371 Date: Jan. 2, 2025

(30) Foreign Application Priority Data
Jul. 8, 2022 (SE) 2250879-0

(51) Int. Cl. C09D 5/16; A01N 25/12; A01N 59/20; A01P 15/00; C09D 1/00; C09D 7/61

(52) U.S. Cl. CPC C09D 5/1618; A01N 25/12; A01N 59/20; A01P 15/00; C09D 1/00; C09D 5/1662; C09D 7/61

(57) ABSTRACT

The present document is directed to an antifouling composition comprising an amorphous, porous and hydrophilic silica material and a multivalent metal compound wherein the multivalent metal compound is distributed inside a pore structure of the silica material. The composition is configured for a controlled release of multivalent metal compound, wherein the release rate of multivalent metal compound is lower than 5 μg/cm²/day. The present document is also directed to a method for preparing an antifouling composition, a formulation comprising an antifouling composition, and use of such a composition and/or formulation.

### TECHNICAL FIELD

The present invention pertains to an antifouling composition. It further relates to methods for preparing an antifouling composition, to a formulation comprising an antifouling composition, and to use of an antifouling composition or composition for protecting a surface against biofouling.

### BACKGROUND OF THE INVENTION

Fouling, i.e., growth of for example, algae, mussels and barnacles on boat hulls, can cause problems as such growth increases the boat's drag in the water and thus the boat's fuel consumption and exhaust gas emissions. Antifouling paints are therefore commonly used to prevent fouling. Traditional antifouling paints with biocides are toxic to plants and animals found in the water around the boat. Alternatives to paints with biocides can be mechanical methods or paints that prevent fouling through physical means. However, antifouling paints that contain biocides can pose a risk to aquatic organisms. Consequently, it is difficult not to harm the environment when trying to protect the boat hull from marine growth.

Since the use of antifouling paints with biocides can result in the release of harmful substances into coastal waters where there are sensitive aquatic organisms, it is vital to find alternatives to antifouling paints that contain biocides. Another route is to make safer use of biocides by reducing concentration and/or enabling a more controlled release of them to ensure that the added amount is effectively used for antifouling rather than ending up in the seafloor sediment as a toxic contaminant.

In view of the above, there is a need of an improved environmentally friendly antifouling composition with high antifouling performance having a significantly reduced chemical footprint for use in antifouling applications.

### SUMMARY OF THE INVENTION

An object of the present invention is to overcome or at least mitigate some of the problems associated with the prior art. In particular, it is an object to provide an antifouling composition and formulation with reduced environmental impact in comparison with traditional antifouling compositions and formulations.

One or more of the above objects may be achieved with an antifouling composition according to claim 1. Variations of the disclosure are set out in the dependent claims and in the following description.

According to a first aspect, the present invention provides an antifouling composition comprising:
an amorphous, porous and hydrophilic silica material;
a multivalent metal compound,
   wherein the multivalent metal compound is distributed inside a pore structure of the silica material.

The present invention also provides an antifouling composition consisting of:
an amorphous, porous and hydrophilic silica material;
a multivalent metal compound,
   wherein the multivalent metal compound is distributed inside a pore structure of the silica material.

The present inventors have surprisingly found that it is possible to produce an antifouling composition having a lower concentration/amount of biocidal metals but with remained or improved antifouling efficiency and with a better controlled release of the biocidal metal ions than conventional antifoulants. This is achieved thanks to the properties of the silica material in terms of the porous and amorphous structure and the hydrophilicity, and to the multivalency of the metal compound. Herein, the multivalent metal compound is used as an active substance intended to destroy, deter, render harmless, prevent the action of, or otherwise exert a controlling effect on harmful or undesired organisms.

Hence, the antifouling composition as disclosed herein is configured to release a multivalent metal compound comprising multivalent metal ions that prevent fouling. In comparison with traditional antifouling paints using copper (I) oxide (Cu₂O), the present invention using a multivalent metal compound in combination with an amorphous, porous and hydrophilic silica material as a carrier results in a formulation having a low release rate and thus a higher/remained antifouling effect that will last during a longer period of time.

Due to its high surface area and its porous structure, the silica material according to the present disclosure provides an effective mechanical anchoring to keep the active substance, i.e., the multivalent metal compound, in place. Since the silica material is hydrophilic, a low release rate may be achieved.

Further, the release rate of active substance when incorporated in the porous amorphous silica is more controlled and steered towards biological hindering growth on vessels, hull of boats and other sub sea level equipment instead of just leaking out into the water and sea floor sediments. Hence, the concentration of the active substance can be kept significantly lower, up to ten times lower, than today available commercial products whereas the antifouling effect is at least as good.

In the antifouling composition as disclosed herein, the multivalent metal compound may be a bi-valent metal compound.

Optionally, the antifouling composition, as disclosed herein may be configured to release the bi-valent metal compound, e.g., comprising bi-valent metal (II) ions.

In the antifouling composition as disclosed herein, the silica material may have a BET surface area of at least 200 m²/g. The relatively large BET surface area is beneficial for the adsorption efficiency of the antifouling composition and increases the uptake of an active biocidal substance, such as the multivalent metal compound.

Optionally, the silica material may have a BET surface area of at least 240 m²/g, such as at least 255 m²/g.

In the antifouling composition as disclosed herein, the silica material may have an average pore size of from 4 nm to 15 nm.

Optionally, the silica material may have an average pore size of from 6 nm to 12 nm, such as from 8 nm to 10 nm.

In the antifouling composition as disclosed herein, the silica material may have a pore volume of from 0.3 to 1 cm³/g.

Optionally, the silica material may have a pore volume of from 0.5 to 0.9 cm³/g, such as from 0.6 to 0.8 cm³/g.

The multivalent metal compound is distributed onto the surface inside the porous structure of the silica material. The very large surface area of the silica material, due to its specific average pore size, pore volume and BET surface, thereby provides an effective distribution of the metal compound at a relatively low concentration, i.e., the concentration of the biocidal compound needed is less than for conventional antifoulants.

Furthermore, the morphology of the amorphous silica material having this specific BET surface area, average pore size and pore volume provides an effective mechanical anchoring to keep the multivalent metal compound in place.

Furthermore, the combination of a bi-valent metal compound and the silica material as described herein has according to the present invention been found to be particularly beneficial for anchoring the bi-valent metal compound in place.

Thus, the present antifouling composition as disclosed herein has an enhanced permeability for the biocidal compound in comparison to conventional antifoulants.

The porous silica material may be meso-, micro-, macro- and/or nanoporous.

Further, the silica material may be a precipitated silica material such as a silica material commercially available under the tradename Quartzene® from Svenska Aerogel AB, such as Z1 Quartzene® or variants thereof. Such precipitated silica can be efficiently produced in large scale and may therefore advantageously be used. The silica material may accordingly be a silicon dioxide.

Further, the precipitated silica material may have a density within the range of from 0.005 to 0.5 g/cm³, such as from 0.025 to 0.3 g/cm³, such as from 0.05 to 0.1 g/cm³. Optionally, the precipitated silica material may have a density within the range of from 0.005 to less than 0.05 g/cm³, such as from 0.025 to 0.048 g/cm³.

Alternatively, the silica material may be a silica aerogel.

In the antifouling composition as disclosed herein, the multivalent metal compound may comprise a metal selected from the group consisting of copper, zinc, silver, zirconium, and titanium. Hence, the multivalent metal compound may be any one or more of a copper compound, a zinc compound, a silver compound, a zirconium compound, and a titanium compound.

Further, in the antifouling composition as disclosed herein, the multivalent metal compound may be a bi-valent copper compound.

In a conventional ablative antifouling paint, single valent copper that has not yet been oxidized may be lost. A coating, made by conventional ablative antifouling painting will thus release copper compound that has no antifouling function into the ocean. By using a bi-valent copper compound, a more environmentally friendly antifouling composition will be achieved. Also, a significantly reduced amount of copper is needed.

Further, the density of the antifouling composition may be in the range of from 0.100 to 0.400 g/cm³, such as from 0.150 to 0.350 g/cm³, such as from 0.200 to 0.300 g/cm³.

Optionally, in the antifouling composition as disclosed herein, the multivalent metal compound may be copper hydroxide Cu(OH)₂.

Optionally, the multivalent metal compound may be present in the antifouling composition as disclosed herein in an amount of from 5 to 15 percent by weight (wt %) of dry matter. The silica material may be present in the antifouling composition as disclosed herein in an amount of from 85 to 95 wt % of dry matter.

Optionally, the antifouling composition as disclosed herein may further be configured to release the multivalent metal compound at a release rate lower than 5 μg/cm²/day, such as lower than 4 μg/cm²/day, such as lower than 3 μg/cm²/day, such as lower than 1.8 μg/cm²/day. This is due to the amorphous, highly porous and hydrophilic silica material as described herein in combination with the multivalent metal component. A low release of the multivalent metal ions implies that a lower amount of multivalent metal compound is needed to be incorporated in the silica material from the beginning and that the antifouling effect will last for a longer time whereas the antifouling effect is remained.

According to a second aspect, the present invention further provides a method for preparing an antifouling composition as disclosed herein, the method comprising:
a) providing a waterglass solution and a salt solution;
b) providing a water solution comprising multivalent metal ions;
c) mixing the waterglass solution and the salt solution to form a slurry comprising silica precipitates, and adding the water solution comprising the multivalent metal ions to the slurry during the mixing,
d) adjusting a pH value of the slurry to about 7-10; and
e) forming the antifouling composition from the slurry.

Alternatively, the method comprises the steps of:
a) providing an amorphous, porous and hydrophilic silica material;
b) providing a water solution comprising multivalent metal ions;
c) mixing the silica material with the water solution comprising multivalent metal ions to form a slurry, whereby the multivalent metal ions penetrate into a pore structure of the silica material;
d) adjusting a pH value of the slurry to about 8-10; and
e) forming the antifouling composition from the slurry.

The amorphous, porous and hydrophilic silica material may in this case be provided in the form of a dry powder, or in the form of a slurry, such as a slurry obtained during precipitation of the silica material but before dewatering and drying.

The methods as disclosed herein may further comprise dewatering and washing of the slurry. Dewatering may be performed in any suitable manner, for instance by filtering under vacuum.

The methods as disclosed herein may further comprise drying of the slurry to form an antifouling composition in the form of a dry powder. Drying may be performed at a temperature between 100 to 140° C. A solid powder-based material may easily be integrated into a formulation such as a coating/paint to bring an efficient and long-lasting antifouling effect.

In the methods as disclosed herein, providing the water solution in step b), may comprise dissolving a multivalent metal base salt into water.

In the methods as disclosed herein, the multivalent metal base salt may be a copper (II) salt.

By preparing the copper salt in a water solution before being added to the porous silica a more beneficial manufacturing is achieved.

In the methods as disclosed herein, the multivalent base salt may be selected from the group consisting of CuSO₄, Cu(NO₃)₂, Cu₃(PO₄)₂, CuCO₃, CuCl, CuCl₂, ZnSO₄, Zn(NO₃)₂, Zn₃(PO₄)₂, TiO(SO₄), Ti(NO₃)₄, Ti₃(PO₄)₄, AgNO₃, AgCl, Ag₂SO₄, Zr(NO₃)₄, Zr(SO₄)₂, ZrCl₄,

In the methods as disclosed herein, the silica material may have a BET surface area of at least 200 m²/g.

Optionally, the silica material may have a BET surface area of at least 240 m²/g, such as at least 255 m²/g.

In the methods as disclosed herein, the silica material may have an average pore size of from 4 nm to 15 nm.

Optionally, the silica material may have an average pore size of from 6 nm to 12 nm, such as from 8 nm to 10 nm.

In the methods as disclosed herein, the silica material may have a pore volume of from 0.3 to 1 cm³/g.

Optionally, the silica material may have a pore volume of from 0.5 to 0.9 cm³/g, such as from 0.6 to 0.8 cm³/g.

According to a third aspect, the present invention is directed to a formulation comprising an antifouling composition as disclosed herein. Optionally the formulation may comprise:
an inorganic filler;
a binder;
a pigment;
a thickener; and
a solvent.

The formulation may, for example, consist of the antifouling composition, and an inorganic filler, a binder, such as a binder in the form of a polymer, a pigment, a thickener, and a solvent.

Optionally, the formulation as disclosed herein may further comprise one or more additives selected among dispersants, biocides, antifoaming agents, wetting agents, emulsifiers, softeners, co-binders and colorants.

The formulation comprising an antifouling composition as disclosed herein can be mixed into various types of antifouling coatings, where the morphology of the silica material provides an effective mechanical anchoring to keep the active substance in place.

According to a fourth aspect, the present invention is directed to use of an antifouling composition according to the first aspect or of a formulation according to the third aspect for protecting a surface of an object which is in contact with water, especially sea water, against biofouling.

### Definitions

The term “multivalent metal compound” as used herein refers to a metal compound having a valence of more than one, i.e., it includes for example metal compounds having a valence of two or three or four etc.

The term “bi-valent metal compound” as used herein refers to a metal compound having a valence of two.

The term “amorphous” as used herein refers to a shapeless, disordered, and/or irregular arrangement of the constituent particles of a solid.

The term “porous” as used herein includes mesoporous, nanoporous, and/or microporous structures.

The term “hydrophilic” as used herein refers to the materials with a special affinity for water. Hydrophilicity is evaluated by measuring the surface contact angle of static water and a surface is defined as hydrophilic when its static water contact angle θ is <90°. Hydrophilicity or hydrophobicity can be also evaluated by Turbidity test using for example a TURBIQUANT 3000 IR turbidimeter.

The term “controlled release rate” as used herein is defined as a release rate of lower than 5 μg/cm²/day.

The “release rate” of copper is measured according to the international standard ISO 15181-2 and using the accredited SP method 5117 wherein the concentration of copper ions is measured, and the copper release rate is thereafter calculated.

### BRIEF DESCRIPTION OF THE DRAWINGS

The product as disclosed herein will be further explained hereinafter with reference to the appended drawings wherein:

FIG. 1 shows a schematic overview of the method steps;

FIG. 2 shows a plot of the XRD analysis of the Z1 Quartzene; and

FIG. 3 shows a TEM micrograph of the Z1 Quartzene.

FIG. 4 shows a XPS Spectrum of an antifouling composition according to an embodiment.

### DETAILED DESCRIPTION

The present invention relates to an antifouling composition comprising an amorphous, porous and hydrophilic silica material. In this case the silica material may have a BET surface area of at least 200 m²/g, such as such as at least 240 m²/g, such as at least 255 m²/g. Further, the silica material may have an average pore size of from 4 nm to 15 nm, such as from 6 nm to 12 nm, such as from 8 nm to 10 nm. Further, the silica material may have a pore volume of from 0.3 to 1 cm³/g, such as from 0.5 to 0.9 cm³/g, such as from 0.6 to 0.8 cm³/g. Further, the silica material may be meso-, micro-, macro- and/or nanoporous. Further, the silica material may be a silicon dioxide, SiO₂. Further, the silica material may be a precipitated silica material may have a density within the range of from 0.005 to 0.5 g/cm³, such as from 0.025 to 0.3 g/cm³, such as from 0.05 to 0.1 g/cm³. Optionally, the precipitated silica material may have a density within the range of from 0.005 to less than 0.05 g/cm³, such as from 0.025 to 0.048 g/cm³.

The antifouling composition further comprises an active substance in the form of a multivalent metal compound, such as a bi-valent metal compound. In this case the multivalent metal compound may be selected from the group consisting of a copper compound, a zinc compound, a silver compound, a zirconium compound, and a titanium compound. In preferred embodiments, the multivalent metal compound may be a bivalent copper compound, such as Cu(OH)₂. The multivalent metal compound may further be ZnO, Zn(OH)₂, Ag₂O or AgOH.

The multivalent metal compound may be present in the antifouling composition in an amount of 5-15 wt %. Hence, the silica material may be present in the antifouling composition in an amount of 85-95 wt %.

Further, the antifouling composition may be configured to release bi-valent metal (II) ions.

Further, the multivalent metal compound of the disclosed antifouling composition is distributed inside a pore structure of the silica material.

Further, the antifouling composition may be configured for a controlled release of the metal compound, such as comprising bi-valent metal (II) ions, wherein the release rate of the multivalent metal compound may be lower than 5 μg/cm²/day, such as lower than 4 μg/cm²/day, such as lower than 3 μg/cm²/day, such as 1.8 μg/cm²/day.

Optionally, the antifouling composition as described herein is configured for a release of total copper in the form of e.g. Cu⁺² ions, i.e., copper carrying a double positive charge, wherein the release rate of the total copper is lower than 5 μg/cm²/day, such as lower than 4 μg/cm²/day, such as lower than 3 μg/cm²/day, such as lower than 2 μg/cm²/day, such as lower than 1.8 μg/cm²/day. Further, the density of the antifouling composition may be in the range of from 0.100 to 0.400 g/cm³, such as from 0.150 to 0.350 g/cm³, such as from 0.200 to 0.300 g/cm³.

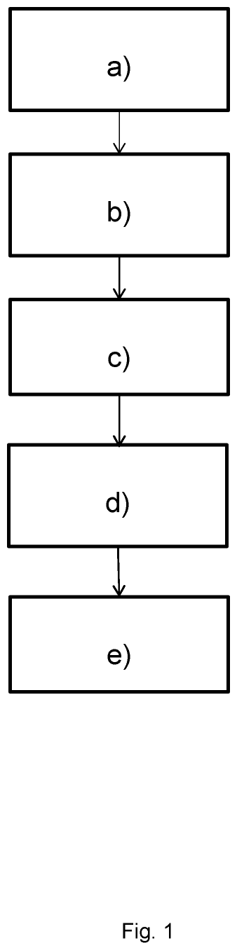

The present invention further relates to a method for preparing an antifouling composition as illustrated in FIG. 1. In a first step a), an amorphous, porous, and hydrophilic silica material is provided. In this case the silica material may have a BET surface area of at least 200 m²/g, such as at least 240 m²/g, such as at least 255 m²/g. Further, the silica material may have an average pore size of from 4 nm to 15 nm, such as from 6 nm to 12 nm, such as from 8 nm to 10 nm. Further, the silica material may have a pore volume of from 0.3 to 1 cm³/g, such as from 0.5 to 0.9 cm³/g, such as from 0.6 to 0.8 cm³/g. Further, the silica material may be meso-, micro-, macro- and/or nanoporous. Further, the silica material may be a silicon dioxide.

In a second step b), a water solution comprising multivalent metal ions is provided. The water solution may be obtained by dissolving a multivalent metal base salt into water. In this case, the multivalent metal multivalent metal base salt may be a copper (II) salt. The multivalent base salt may further be selected from the group consisting of CuSO₄, Cu(NO₃)₂, Cu₃(PO₄)₂, CuCO₃, CuCl, CuCl₂, ZnSO₄, Zn(NO₃)₂, Zn₃(PO₄)₂, TiO(SO₄), Ti(NO₃)₄ and Ti₃(PO₄)₄, AgNO₃, AgCl, Ag₂SO₄, Zr(NO₃)₄, Zr(SO₄)₂, ZrCl₄.

In a third step c), the silica material is mixed with the water solution comprising multivalent metal ions to form a slurry whereby the multivalent metal ions penetrate the pore structure of the silica material. This step may be performed using an IKA mechanical stirrer, RW 20 digital with a stainless steel based stirring rod with a rotation speed of 800-900, such as 860 RPM during a period for 3-5 hours. Further this step can be performed at an ambient temperature, such as about 20-22° C.

In a fourth step d), the pH value of the slurry is adjusted to about 8-10, such as to about 9, by slowly adding a 0.5-3M NaOH solution. In the case the multivalent metal base is CuSO₄, the change in pH to about 9 will change the solubility and leading to precipitation of the copper to form Cu(OH)₂.

In a fifth step e), formation of the antifouling composition is performed from the slurry. This step may also comprise dewatering and washing of the slurry. Further, this step may also comprise drying of the slurry to form the antifouling composition in the form of a dry powder.

In an alternative method for preparing an antifouling composition, the following steps are carried out:
a) providing a waterglass solution and a salt solution;
b) providing a water solution comprising multivalent metal ions;
c) mixing the waterglass solution and the salt solution to form a slurry comprising silica precipitates, and adding the water solution comprising the multivalent metal ions to the slurry during the mixing,
d) adjusting a pH value of the slurry to about 7-10; and
e) forming the antifouling composition from the slurry.

The present invention further relates to a formulation comprising an antifouling composition as disclosed herein comprising an inorganic filler, a binder, a solvent, a pigment, and a thickener.

The inorganic filler may be one or more of calcium carbonate, titanium dioxide, kaolinite, talc, gypsum, calcined kaolin, or other fillers commonly used in the field.

The binder may be one or more of a polymer, polyvinyl alcohol, synthetic latex such as styrene-butadiene latex, styrene-acrylate latex, and/or polyvinyl acetate latex, acrylic resins, cellulose derivatives, carboxymethyl cellulose (CMC), starch, protein, rosin or other binders commonly used in the field.

The thickener, or viscosity modifier, may be one or more of CMC, starch, soy protein, casein, alginate, hydroxyethyl cellulose, acrylic polymers, or other thickeners commonly used in the field.

The solvent may be one or more of water, xylene, hydrocarbons, benzene, toluene, ethylbenzene, mixed xylenes (BTEX), Naphtha, or other solvents used in the field.

Optionally, the formulation may further comprise one or more additives selected among dispersants, biocides, antifoaming agents, wetting agents, emulsifiers, softeners, co-binders and colorants.

### EXPERIMENTAL SECTION

### Example 1

In Example 1, an antifouling composition AF1 was prepared using an amorphous, porous and hydrophilic silica material in the form of a dry powder, to which a water solution comprising multivalent metal ions was added, followed by mixing to form a slurry.

### Characterization of the Silica Material Z1 Quartzene®

Z1 Quartzene® was provided from Svenska Aerogel AB. The silica material Z1 Quartzene® was characterized by performing an X-ray diffractogram (XRD) analysis, Transmission Electron Microscope (TEM) micrograph and measuring its BET surface area, pore volume and average pore size.

The Brunauer-Emmett-Teller (BET) technique was used to determine the Surface Area, Pore Volume and average Pore Size of the porous material as described herein. For the BET test, the nitrogen adsorption analysis was conducted at 77K using a Micromeritics Tristar 3200. The sample (dried powder) was accurately weighed between 0.15 and 0.5 g and added to a sample tube with a known volume. The sample tube was then connected to a degassing system applying a vacuum at elevated temperatures (150° C.) for 24 hours. The analysis started by introducing N2 to the pores. The adsorbed gas volume was then measured at the boiling point of nitrogen (77K). The adsorption-desorption points were collected for the isotherm in the relative pressure range 0-0.99. The specific surface area, pore volume and pore size were then calculated according to BET theory.

XRD analysis was performed using a Bruker D8 Twin-Twin powder X-ray diffractometer. X-ray diffraction (XRD) is a method to validate the crystal structure of a sample. Fitting XRD patterns allows the comparison of known crystalline samples with unknown samples to identify the orientation of a crystal (or grain), the material lattice parameters, the stress in crystalline regions, and secondary phases. In XRD method, X-rays are directed toward the sample. The incident rays interact with the sample atoms and produce constructive interference (and a diffracted ray) when conditions satisfy Bragg's Law (n=λd sin θ). TEM characterization was performed to image the samples' morphological structure using a JEOL instrument with acceleration voltage of 200 kV and Magnification of 2, 4, 12 KX. The TEM images were analyzed using Gatan Digital Micrograph. For TEM sample preparation, a solution of powder and ethanol (99%) was prepared (5 mg/ml). The solution was ultrasound treated for 5 min. Then one drop of the solution was taken and placed on a TEM grid. The TEM grid had 400 Mesh Cu with carbon film. The grid was dried in room temperature and used for TEM analysis.

Table 1 shows the structural analysis of Z1 Quartzene® achieved from BET test.

TABLE 1
Structural analysis of Z1 Quartzene ®

| | | |
|---|---|---|
| BET | 263 | m²/g |
| Pore volume | 0.7 | cm³/g |
| Pore mean size | 9.94 | nm |

The density of Z1 Quartzene was analysed to be in the range of from 0.05 g/cm³ to 0.1 g/cm³.

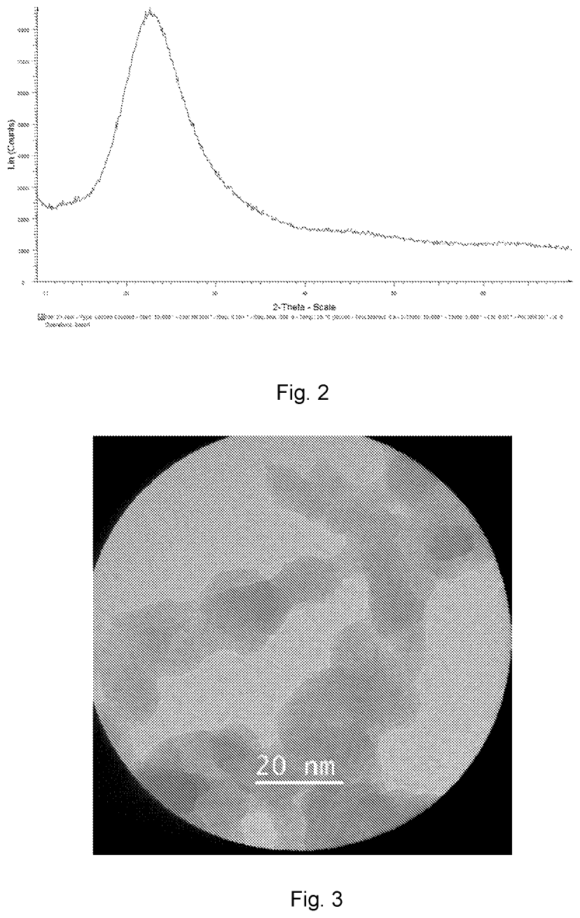

FIG. 2 shows the plot from the XRD analysis and confirms that the Z1 Quartzene is amorphous. The y-axis represents the relative intensity of the diffracted beam and the x-axis represents the angle 2θ, i.e. the angle between the transmitted beam and the reflected beam.

FIG. 3 shows the TEM micrograph which indicates that the Z1 Quartzene material has pore size that varies between 5 nm and 20 nm.

### Preparation of Antifouling Composition AF1

### Example 1

In this example, an antifouling composition AF1 was prepared using a bi-valent Cu²⁺ base salt and a Z1 Quartzene® dry powder.

### Materials Used:

CuSO₄*5H₂O,
Z1 Quartzene® dry powder suppled from Svenska Aerogel AB,
Deionized water,
1M NaOH solution.

9750 g of deionized water was mixed with 250 g of CuSO₄×5H₂O. Thereafter, 640 g of Z1 Quartzene® dry powder was added which resulted in pH=4.56. The blend of copper containing solution and the Z1 Quartzene® dry powder was then further mixed for 3.5 hours using IKA mechanical stirrer, RW 20 digital with a stainless steel based stirring rod at 860 RPM and ambient temperature to form a slurry. During mixing, the copper containing solution was allowed to absorb into the hydrophilic Z1 Quartzene® powder by penetrating pores and cracks. After completed absorption, after mixing procedure, pH was slowly adjusted by adding a 1M NaOH-solution, to pH about 9. The slurry was left to settle for 36-48 hours. The adjustment of pH to about 9 resulted in a change in solubility and thereby a precipitation of the copper to form Cu(OH)₂. The slurry was then dewatered and washed four times using a Buchner funnel with vacuum suction whereby a pasta was achieved. Each ¼-part of the slurry was washed three times with about 1.5-2 liters of tap water (i.e., 4×3×1.5−2 liters, about 20 liters in total). The pasta was finally dried overnight in trays in a heating cabinet at 130° C. in order to attain the final antifouling composition.

### Analysis of the Surface Chemical Composition of AF1 by X-Ray Photoelectron Spectroscopy (XPS)

The surface chemical composition of the antifouling composition AF1 comprising Quartzene® and Cu(II) was obtained using XPS. The XPS method provides the surface chemical composition expressed in atomic % for the outermost 2-10 nanometers of the surface.

The measuring principle is that a sample, placed in high vacuum, is irradiated with well-defined x-ray energy resulting in the emission of photoelectrons. Only photoelectrons from the outermost surface layers reach the detector. By analyzing the kinetic energy of these photoelectrons, their binding energy can be calculated, thus giving their origin in relation to the element and the electron shell.

XPS spectra were recorded using a Kratos AXIS UltraDLD x-ray photoelectron spectrometer (Kratos Analytical, Manchester, UK). The samples were analyzed using a monochromatic Al x-ray source. The relative surface composition in atomic %, quantified from XPS is shown in Table 2.

TABLE 2
Relative surface composition of AF1

| Element | C | O | Si | Cu | Ni | F | Na | Ca | S |
|---|---|---|---|---|---|---|---|---|---|
| Atomic % | 0.7 | 73.9 | 21.7 | 2.3 | 0.4 | — | 0.5 | (<0.1) | 0.5 |

— = signal in detail spectra at noise level (below about 0.05 atomic %)
( ) = weak peak, signal close to noise level in detail spectra.

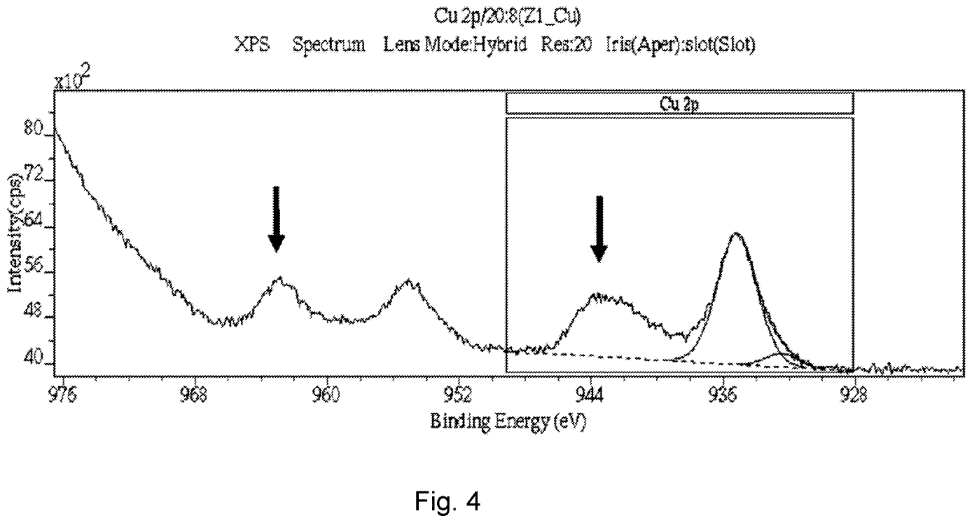

To identify the presence of Cu(II) as well as Cu(OH)₂ in the AF1 sample, a high-resolution spectrum was run. The total amount of copper and two major peaks appear in the related spectra (see FIG. 4). The major peak is the Cu(II)-peak which appears at about 935.2-4 eV. The peak position on the binding energy scale and the presence of shake-up satellite peaks (arrows) indicate strongly that copper is present as Cu(II), particularly since Cu(I) does not have any satellite peaks. Cu(II) could for example be in the form of CuO or Cu(OH)₂. However, based on the binding energy position for the peak, this is an indication that copper might be in the form of Cu(OH)₂.

The minor peak is the Cu(I)-peak and appears at about 932.5-7 eV. The peak position on the binding energy scale indicates that copper is present either in the form of Cu(I) such as Cu₂O, or Cu (metal).

TABLE 3
The total amount of copper and the
two peaks that appear in spectra

| Element | Cu tot | Cu tot | Cu(II) | Cu(I) |
|---|---|---|---|---|
| Atomic % | 2.3 | 100 | 92 | 8 |

### Measurement of the Release Rate

The purpose of this experiment was to determine the release rate of total copper e.g., in the form of Cu⁺² (μg/cm²/day) from an experimental antifouling formulation, i.e., paint, containing 27 wt % (i.e., weight percent of dry paint) of the antifouling composition AF1 prepared as described above. The composition AF1 contains 9 wt % of copper. Thus, the formulation analyzed in this release rate study contains a nominal concentration of 2.4 wt % Cu (in weight percent of dry paint).

Extraction of biocide from antifouling paint films were performed under specific laboratory conditions in accordance with ISO 15181-1:2007 (equivalent to ASTM D64442-06) into artificial substitute ocean water, SOW, prepared according to ASTM D 1141-98 (Reapproved 2003). The main parameters in the experiment and the deviations from the standards are the following:
I. As specified in the ISO 15181-1: Temperature of the SOW in the holding tank has been kept at 25° C. (+/−1° C.).
II. As specified in the ISO 15181-1: Temperature for the release rate measuring tanks kept at 25° C. (+/−1° C.).
III. As specified in the ISO 15181-1: Rotational speed of the cylinders under extraction has been set to 60 (+/−1) revolutions per minute (rpm).
IV. As specified in the ISO 15181-1: The synthetic ocean water used in this study has been prepared according to Standard method ASTM D 1141 (as also required in the equivalent ASTM D6442-06). The ASTM D 1141 “Substitute ocean water” (SOW) has been prepared according to the method and checked for salinity range 33-34 practical salinity units (psu) and pH 7.9-8.1, just as required by ISO 15181-1.
V. Deviation in number and timing of sampling: in order to create a smaller study the sampling has been taken weekly for 6 weeks, instead of as stated in the standards.

Analysis of the concentration and calculation of the release rate for the biocide (copper ions) extracted was performed according to the ISO 15181-2:2007 (equivalent to ASTM D6442-06). The sample was frozen until analysis by ICP-MS.

### Paint Application and Specimen Preparation

A paint formulation comprising the antifouling composition AF1 as described above was prepared. The components of the paint formulation are shown in Table 4.

TABLE 4
Components of the paint formulation

| Component | Mass (g) | Mass (%) wet | Mass (%) dry |
|---|---|---|---|
| Xylene | 38 | 40.6 | |
| Hydrogenated | 8 | 8.6 | 14.4 |
| Rosin | | | |
| Acrylic co-polymer | 9 | 9.6 | 16.2 |
| Lecithin | 0.5 | 0.5 | 0.9 |
| Dialkyl (C7-C9) | 2 | 2.1 | 3.6 |
| phenyl phtalate | | | |
| AF1 | 15 | 16.0 | 27.0 |
| ZnPt | 3 | 3.2 | 5.4 |
| Fe₂O₃ | 8 | 8.6 | 14.4 |
| BaSO₄ | 10 | 10.7 | 18.0 |

Prior to the painting, the surface of the cylinders that were to be painted was cleaned, rinsed, and then abraded with 200 grit paper to promote adhesion. The abraded surface was then wiped and washed with Milli-Q® water and let dry. The cylinders were further marked and weighed before painting.

Before the application of the antifouling product to be studied i.e., the paint formulation comprising the antifouling composition AF1, a first layer of primer was applied. The height of the painted area on each cylinder was 100 mm. This resulted in a total painted area per cylinder of about 219.8 cm².

The paint was applied by roller on rotating cylinders in order to achieve a homogenous paint film thickness. The application was repeated with 24 h intervals for drying until the thickness was well inside the range specified from the ISO 15181-1 standard.

The painted cylinders as well as a “blank” non-painted cylinder were put in a holding tank (aquarium) comprising substitute ocean water (SOW). The temperature in the holding tank (aquarium) was maintained constant by immersing it in an external temperate water bath kept at 25° C. The external temperate water bath comprised a deionized thermostatically controlled water bath maintained at 25° C. and recirculated in order to maintain the 30 L SOW containing holding tank (aquarium) at constant 25° C. during the whole study (42 days).

Prior to each measurement, “release rate measuring containers” containing 1.5 L fresh SOW were also immersed in the holding tank bath in order to allow the temperature of the SOW contained in the release rate measuring containers to reach 25° C. (+/−1° C.). The extraction of biocide was made mounting the painted and blank cylinders (screw caps) on a rotating device calibrated to 60 (+/−1) rpm and immerging the cylinders in the middle of the release rate measuring containers, rotating for 1 h.

Triplicate samples were taken weekly for 6 weeks and were taken from the release rate tank after the rotating period of 1 h was finished and the cylinder were moved back to the holding tank. A volume of 49 ml of the release rate measuring container SOW was stored in a 50 ml centrifuge tube and added with 200 μl nitric acid. The samples were kept at −40° C. until the end of the extraction period of 45 days. Then, prior to concentration analysis, the samples were thawed at room temperature. The samples collected according to ISO 15181-1:2007, were analysed for Cu using ISO 15181-2:2007, with accredited SP method 5117. The samples were diluted 10 times with 1% nitric acid, internal standard added and the concentration of Cu was determined with SF-ICP-MS (Element 2, Thermo Finnigan). Both Cu⁶³ and Cu⁶⁵ were measured, but Cu⁶⁵ was used for quantification, using a calibration curve in matrix matched standard solutions. The concentrations and release rate were calculated according to the ISO 15181-2 as specified in the property SP5117 V.1 method validated in 2014 at the RISE institute (former known as SP institute) and accredited. As validated in the SP5117, the method used for analysis of copper concentration and release rate calculation had a limit of detection (LOD)≤10 μg/L Cu, as required by ISO 15181-1.

The ≤10 μg/L Cu LOD for the “Cu concentration” gives a calculated LOD for the “Cu release rate” of 1.8 μg/cm²/day. This simply by mathematical correlation between concentration and release rate described here under in the Equation 4 (also present in the SP5117 method):

Rd=(Ccu*V*24)/(t*A) Equation 4:

### Where:

C_{cu}: is the concentration of copper
24: is the number of hours in a day
T: is the length of time in hours the cylinder was immersed and rotated in the measuring container (in this case 1 hour)
V: is the volume of artificial sea water (SOW) in the measuring container (in this case 1.5 L)
A: is the surface area of the paint film (in this case 219.8 cm²)

### Mean Concentration and Mean Release Rate for Each Set of Cylinders

The mean Cu concentration and release was identified by SF-ICP-MS in the AF1 samples. The mean Cu concentration of three samples of the AF1 samples at each time point and the mean Cu release rate for the same samples were measured and are shown in Table 5.

The quantification limit for the release rate of Cu was approx. 1.8 μg/cm²/day. All the values from week 3 forward were found to be under the LOD, thus according to the convention in the Biocide Product Regulation for reporting data, these points were set to ≤LOD.

TABLE 5
Cu concentration and release of Cu in the AF1 formulation

| | | | Mean release | |
|---|---|---|---|---|
| | Mean Cu conc. | STD | rate of Cu | STD |
| Day | (μg/l) | (μg/l) | (μg/cm²/day) | (μg*cm⁻²*d⁻¹) |
| Day 7 | 15 | 2 | 2.7 | 0.3 |
| Day 14 | 12 | 1 | 2.2 | 0.2 |
| Day 21 | 10 | 0 | 1.9 | 0.2 |
| Day 28 | ≤10 | NA | ≤1.8 | NA |
| Day 35 | ≤10 | NA | ≤1.8 | NA |
| Day 42 | ≤10 | NA | ≤1.8 | NA |

Quantification limit for the Cu concentration is approximately 10 μg/l. Quantification limit for the release rate of Cu is approximately 1.8 μg/cm²/day. NA refers to standard deviation, STD, for values equal to or below the LOD.

As can be seen in Table 5, the mean release rate of Cu is as low as 2.7 μg/cm²/day at day 7 and equal to or lower than 1.8 μg/cm²/day at day 42, i.e., after six weeks.

Taken together, the results clearly demonstrate that the amount of the active ingredient, such as a bi-valent metal compound, for example Cu, can be significantly lower compared to other products on the market today without compromising the effect.

### Example 2

In Example 2, an antifouling composition AF2 was prepared from a slurry comprising an amorphous, porous and hydrophilic silica material, to which a water solution comprising multivalent metal ions was added, followed by mixing.

### Materials Used:

CuSO₂*5H₂O,
Z1 Quartzene® slurry supplied from Svenska Aerogel AB,
Deionized water,
2.5 M NaOH solution.

A copper solution containing 1 liter of deionized water and 28.3 g of CuSO₄*5H₂O (blue solution), with a pH value of 7.5, was added to 5 kg of the slurry directly after a mixing stage of the Z1 Quartzene® slurry. The copper solution was slowly added during mixing at a speed of 327 rpm, resulting in a pH value of 4.8. To allow the copper to attach to the SiO₂, a solution of 2.5 M NaOH was added to the solution to reach a pH of 7.7. The solution was washed under water until a conductivity of <200 μs/cm of the washing water was achieved, thereafter dried in oven at 100° C. for one night and finally grinded with a lab grinder from IKA to reach the desired particle size.

### Example 3

In Example 3, an antifouling composition AF3 was prepared by adding a water solution comprising multivalent metal ions during the precipitation of sodium silicate with sodium chloride, in the mixing stage.

### Materials Used:

NaCl solution,
Waterglass mixture,
H₂SO₄,
NaOH solution,
CuSO₂*5 H₂O.

A waterglass mixture containing 1.3 kg water H₂O (18±1° C.), 110 g sodium silicate solution and 14 g glycerol was prepared in a 5 liters container. A first dosage with H₂SO₄ (37%) acid was added slowly during 21 min until the pH value was 9.4. The NaCl solution, containing 65 g NaCl and 272 g tap water, was added when the precipitated particle size reached 5 nm. A second dosage with H₂SO₄ (37%) acid was thereafter added until the pH value was 9. The CuSO₂*5 H₂O solution was thereafter added and the resulting pH value was 5.9. The pH value was subsequently adjusted by slowly adding NaOH (25%) until the pH value was 7.5. The resulting slurry was covered and kept under mixing for one night.

The next day the pH value was measured to 7.6. The slurry was washed in water under pressure until a conductivity of <200 μs/cm of the washing water was achieved. The resulting paste was collected and dried in a glass recipient for one night under T=90° C. and milled into the desired particle size with an IKA grinder.

### Example 4

In Example 4, an antifouling composition AF4 was prepared by adding a water solution comprising multivalent metal ions during the precipitation of sodium silicate with sodium chloride, in the mixing stage.

### Materials Used:

NaCl solution,
Waterglass mixture,
H₂SO₄,
CuSO₂*5 H₂O.

A waterglass mixture containing 1.3 kg water H₂O (18±1° C.), 110 g sodium silicate solution and 14 g glycerol was prepared in a 5 liters container. A first dosage with H₂SO₄ (37%) acid was added slowly during 21 min until the pH value was 9.4. The NaCl solution, containing 65 g NaCl and 272 g tap water, was added when the precipitated particle size reached 5 nm. A second dosage with H₂SO₄ (37%) acid was thereafter added until the pH value was 9.7. The CuSO₂*5 H₂O solution was thereafter added and the resulting pH value was 7.6. The resulting slurry was covered and kept under mixing for one night. The following day, the pH value was 7.7. The slurry was washed in water under pressure until a conductivity of <200 μs/cm of the washing water was achieved. The resulting paste was collected and dried in a glass recipient for one night under T=90° C. and milled into the desired particle size with an IKA grinder.

Density, particle size distribution in terms of d(10), d(50) and d(90), surface area (SA), pore volume (PV) and average pore size (PS) of samples AF2-AF4 produced according to Examples 2-4 are presented in Table 6.

TABLE 6

| | Density | d(10) | d(50) | d(90) | SA | PV | PS |
|---|---|---|---|---|---|---|---|
| Sample | (g/ml) | (μm) | (μm) | (μm) | (m2/g) | (cm3/g) | (nm) |
| AF2 | 0.193 | 3.41 | 26.3 | 89 | 348.4563 | 0.812686 | 8.5879 |
| AF3 | 0.169 | 2.73 | 23.5 | 118 | 600.9927 | 0.795298 | 4.9512 |
| AF4 | 0.297 | 4.36 | 38.5 | 123 | 454.9136 | 0.741525 | 6.0125 |

It is to be understood that the present invention is not limited to the embodiments described above and illustrated in the drawings; rather, the skilled person will recognize that many changes and modifications may be made within the scope of the appended claims.

1. An antifouling composition, comprising:
an amorphous, porous and hydrophilic silica material;
a bi-valent metal compound, wherein the bi-valent metal compound is copper hydroxide Cu(OH)₂ present in the composition in an amount of 5-15 wt %;
wherein the bi-valent metal compound is distributed inside a pore structure of the silica material.

2. (canceled)

3. The antifouling composition according to claim 1, wherein the antifouling composition is configured to release the bi-valent metal compound.

4. The antifouling composition according to claim 1, wherein the silica material has a BET surface area of at least 200 m²/g.

5. The antifouling composition according to claim 1, wherein the silica material has an average pore size of from 4 nm to 15 nm.

6. The antifouling composition according to claim 1, wherein the silica material has a pore volume of from 0.3 to 1 cm³/g.

7-11. (canceled)

12. The antifouling composition according to claim 1, wherein the silica material has a density within the range of from 0.005 to 1 g/cm³.

13. The antifouling composition according to claim 1, wherein the density of the composition is in the range of from 0.100 to 0.400 g/cm³.

14-20. (canceled)

21. A formulation comprising an antifouling composition according to claim 1, further comprising:
an inorganic filler;
a binder;
a solvent;
a pigment;
a thickener; and
one or more additives comprising at least one of dispersants, biocides, antifoaming agents, wetting agents, emulsifiers, softeners, co-binders or colorants.

22. (canceled)

23. A method of using the antifouling composition according to claim 1, comprising protecting a surface of an object which is in contact with water against biofouling.

24. The method according to claim 23, wherein the water comprises sea water.

25. A method of using the formulation according to claim 21, comprising protecting a surface of an object which is in contact with water against biofouling.

26. The method according to claim 25, wherein the water comprises sea water.

27. The antifouling composition according to claim 1, wherein the silica material has a density within the range of from 0.025 to 0.5 g/cm³.

28. The antifouling composition according to claim 1, wherein the silica material has a density within the range of from 0.05 to 0.1 g/cm³.

29. The antifouling composition according to claim 1, wherein the density of the composition is in the range of from 0.150 to 0.350 g/cm³.

30. The antifouling composition according to claim 1, wherein the density of the composition is in the range of from 0.200 to 0.300 g/cm³.
